(19) United States
(12) Patent Application Publication
(10) Pub. No.: US 2010/0042254 A1
(43) Pub. Date: Feb. 18, 2010

(54) METHOD OF FEEDING FLATTENED CARDBOARD CARTONS IN A CARTON OPENING MACHINE IN A BOTTLE, CONTAINER, OR ARTICLE PACKAGING PLANT, AND A DEVICE THEREFOR

(76) Inventors: Helmut VAN HEEK, Bedburg-Hau (DE); Thomas LELIE, Kleve (DE); Dirk HOLTMANN, Kleve (DE); Michael JOERISSEN, Bedburg-Hau (DE); Josef DUPPER, Bedburg-Hau (DE)

Correspondence Address: NILS H. LJUNGMAN & ASSOCIATES, P. O. BOX 130, GREENSBURG, PA, 15601-0130, US

(21) Appl. No.: 12/371,972

(22) Filed: Feb. 17, 2009

Related U.S. Application Data
(63) Continuation-in-part of application No. PCT/EP2007/007227, filed on Aug. 16, 2007.

(30) Foreign Application Priority Data
Aug. 18, 2006 (DE) 10 2006 038 656.6

(51) Int. Cl. B65H 3/34; G06F 7/00

(52) U.S. Cl. 700/230; 271/18; 271/145

(57) ABSTRACT

Method of feeding flattened cardboard cartons in a carton opening machine in a bottle, container, or article packaging plant, and a device therefor. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2007/007227, filed on Aug. 16, 2007, which claims priority from Federal Republic of Germany Patent Application No. 10 2006 038 656.6, filed on Aug. 18, 2006. International Patent Application No. PCT/EP2007/007227 was pending as of the filing date of this application. The United States was an elected state in International Patent Application No. PCT/EP2007/007227.

### BACKGROUND

1. Technical Field

This present application relates to a method of feeding flattened cardboard cartons in a carton opening machine in a bottle, container, or article packaging plant, and a device therefor. This present application further relates to a magazine device for flat elements in contact with one another with at least one transport device and at least one extraction device, and a method for the control of such a magazine device.

2. Background Information

Background information is for informational purposes only and does not necessarily admit that subsequently mentioned information and publications are prior art.

Magazine devices of this type are used, for example, for the storage and transport of flat elements, such as cardboard blanks, etc., so that they can be fed to packaging machines, for example. To make possible a uniform feed at the conventionally high extraction speeds and to essentially guarantee or promote a continuous supply, such magazines must or should have large capacities and be easily fillable with new blanks.

In applications of this type, a conveyor system is conventionally used in which vertically oriented blanks that are standing next to one another are placed on a conveyor chain. The conveyor chain transports the blanks toward the extraction device. To prevent, restrict, and/or minimize a tipping of the vertically oriented elements, a movable T-square stop is attached to the end of the transport device and must or should be retracted to load the magazine with new blanks. To essentially guarantee or ensure reliable operation, the conveyor chain normally runs at a speed which is faster than the movement of the elements which is determined by the extraction speed.

This configuration leads to the accumulation of a significant contact pressure on the stop in the vicinity of the extraction device which increases steadily with an increasing number of blanks stored at the same time. In larger storage magazines, this contact pressure can increase to the point where the extraction device, which is conventionally realized in the form of vacuum devices, can no longer securely grasp the blanks, which in turn leads to malfunctions and operational disruptions. This disadvantage can cause, among other things, an undesirable limitation of the maximum capacity of the storage magazine.

Some charging devices for a feeder unit for sheets have a conveyor path which is divided in two, the two parts of which are vertically bent with respect to one another so that they enclose an angle of less than one hundred eighty degrees between them. In the vicinity of this bend, there are guide surfaces with retaining screws. The sheets are set in motion by means of a probe which is located on the end. One disadvantage of such a charging device is that on account of its static construction, it is unable to easily handle changing load conditions.

Additional devices for the separation of stacks are used for example for sheets or currency bills.

### OBJECT OR OBJECTS

The object of the present application is to improve magazine devices of this type in several respects so that the problems described above no longer occur. In one possible embodiment, the maximum capacity is increased, the ease of operation is improved and the susceptibility to malfunctions is reduced.

### SUMMARY

The present application achieves this object by a magazine device for flat elements in contact with one another with at least one transport device and at least one extraction device. A retaining device is provided in the direction of transport upstream of the extraction device. A sensor is provided for the measurement of the contact pressure of the flat elements in the vicinity of the extraction device, and the retaining device is realized so that it can be controlled as a function of the measured contact pressure. The present application also achieves this object by a magazine device for flat elements in contact with one another with at least one transport device and at least one extraction device. A retaining device is provided in the direction of transport upstream of the extraction device. The transport device is realized in the form of a conveyor chain with chain links that have an ascending ramp shape in the direction of transport.

The provision of a retaining device makes it possible to reduce the contact pressure of the flat elements in the vicinity of the extraction device to a desired magnitude, so that the extraction can take place safely and reliably under all or substantially all or most operating conditions. For example, the magazine capacity on the far side of the retaining device can be increased practically at will up to the mechanical limits of the transport device without thereby causing malfunctions during the extraction.

In one possible embodiment, the conveyor chain is equipped with chain links that have a ramp shape which rises, for example, in the direction of transport. This configuration significantly improves the process of loading and transporting the elements. For example, new elements can be easily placed on the conveyor chain and pushed in the direction of the elements that are already there. These chain links simultaneously or substantially simultaneously prevent, restrict and/or minimize the lower edge of the elements from slipping backward, so that the end bracket which is required or desired in similar installations is no longer necessary and/or desired. For this purpose, the elements can be oriented with a slight forward tilt in the direction of transport, which further improves the transport.

In other words, the chain links of the conveyor chain may have a substantially triangular or trapezoidal shape as viewed from the side. The triangular shape could be either a right triangle or an obtuse triangle. The top side of each chain link, that is, the side on which the cardboard blanks or flat elements are seated or rest, slopes upwardly in the direction of transport or movement of the conveyor. The sloped top side of each chain link causes the bottom edges of the cardboard blanks or flat elements to slide downwardly and back to thus cause the cardboard blanks or flat elements to be tilted forward slightly, that is, the top edges precede the bottom edges in the direction of movement on the conveyor. The front side of each chain link, that is, the side which faces toward the direction of transport or movement of the conveyor, is disposed substantially perpendicular or at an acute angle with respect to an upper horizontal surface of a magazine section. The front side of each chain link acts as a stop to prevent the cardboard blanks or flat elements seated on the sloped top side of an immediately preceding chain link from sliding or moving too far backwards opposite the direction of transport.

In one possible embodiment of the present application, in the vicinity of the extraction device, a sensor is provided which measures the contact pressure of the elements against a stop in the vicinity of the transport device, for example. Depending on the contact pressure measured, the function of the retaining device can be controlled on the one hand, and alternatively or simultaneously or substantially simultaneously the speed of the transport device can also be controlled. The transport device moves at a speed which results from the extraction speed of the elements and is equal to the speed of movement of the elements toward the extraction device.

This arrangement essentially ensures or promotes that in the vicinity of the extraction device a contact pressure occurs which is not greater than the pressure that can be overcome by the extraction device during the extraction of the elements. This arrangement simultaneously or substantially simultaneously essentially ensures or promotes that a sufficient supply of elements is available at the extraction device, so that the extraction device can also reliably grab the next element, even at high extraction speeds.

The method according to the present application also accomplishes the objects described above.

These and additional configurations of the present application are described below, which are hereby incorporated by reference into the description.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

The present application is described in greater detail below with reference to the accompanying drawings, in which:

FIG. 1 is a schematic side view of a magazine device according to the present application;

FIG. 1A is another view of the magazine device shown in FIG. 1 with additional features;

FIG. 1B is a blown up view of a portion of the magazine device shown in FIGS. 1 and 1A;

FIG. 2 is a schematic plan view of the magazine device for flat elements in contact with one another with at least one transport device and at least one extraction device, wherein a retaining device is provided in the direction of transport upstream of the extraction device;

FIG. 3 is a schematic plan view of the magazine device according to another possible embodiment;

FIG. 4 shows a side view of an adjustable cartoner assembly; and

FIG. 5 shows a perspective view of a portion of the adjustable cartoner assembly according to FIG. 4.

### DESCRIPTION OF EMBODIMENT OR EMBODIMENTS

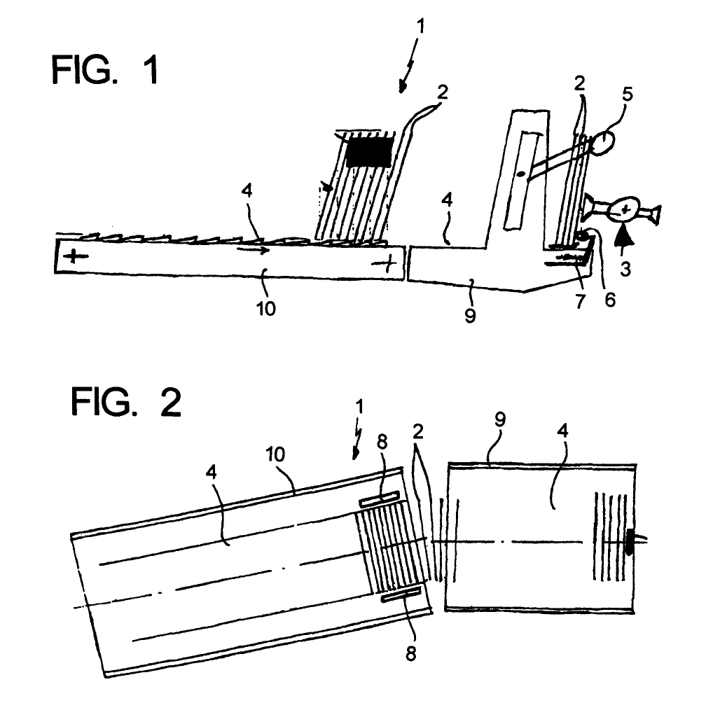

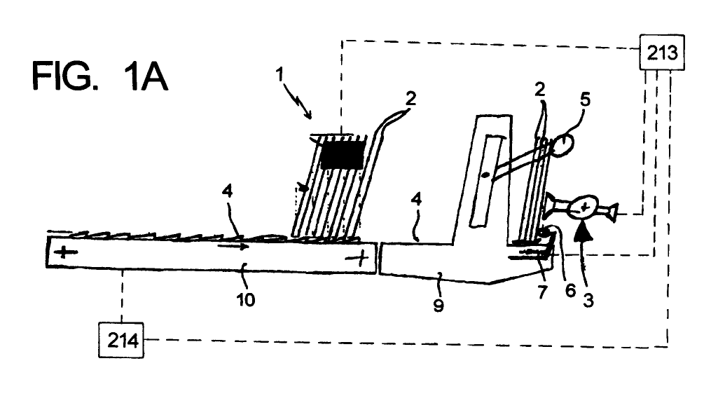

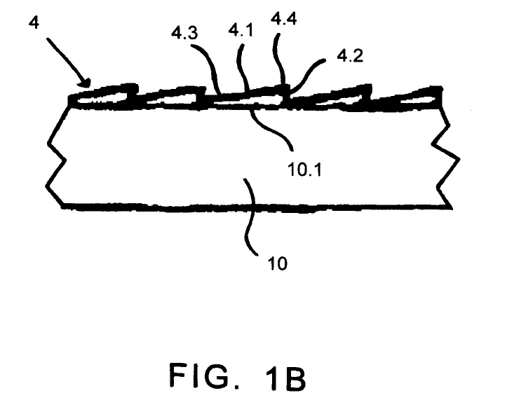

A magazine device which is designated 1 in general is illustrated in greater detail in FIGS. 1 and 2. It is used to store and transport a row of flat elements such as blanks 2 which can be made of cardboard, for example. An extraction device which is designated 3 in general and is in the form of a vacuum gripper extracts the blanks 2 at the end of the device 1 to feed the to a packaging machine. The blanks 2 are placed on the conveyor chain 4 on edge in the area of the magazine part 10 of the device 1 and pushed in the direction of transport of the chain 4 until they come into contact with the blanks 2 that are already there. Because the individual chain links of the conveyor chain 4 are sloped in the direction of transport, a displacement in this direction is easily possible, and at the same time prevents, restricts and/or minimizes the elements from slipping downward.

FIG. 1B is a blown up view of a portion of the magazine device shown in FIGS. 1 and 1A, specifically a portion of the magazine section 10 and the conveyor chain 4. As seen in the figure, the magazine section 10 has an upper edge 10.1 adjacent the conveyor chain 4. The conveyor chain 4 comprises a plurality of teeth or chain links which have a substantially triangular or trapezoidal side profile as shown in FIG. 1B. To further explain, each of the chain links has a top surface 4.1, a front surface 4.2, a first top surface portion 4.3, and a second top surface portion 4.4. The top surface 4.1 of each chain link is sloped in a downward direction away from the direction of movement of the conveyor chain 4, such that the first top surface portion 4.3 is vertically lower than the second top surface portion 4.4. In the embodiment shown, the slope of the top surface 4.1 is substantially constant. In addition, the top surface 4.1 defines an acute angle with respect to the upper edge 10.1 of the magazine section 10, as well as defines an acute angle with respect to the front surface 4.2. The front surface 4.2 defines, in the embodiment shown, an approximate right angle with respect to the upper edge 10.1 of the magazine section 10. However, in other embodiments the front surface 4.2 may be angled such that it defines an acute angle with respect to the upper edge 10.1. The length of the top surface 4.1 is substantially greater than the length of the front surface 4.2. For example, the ratio of the length of the top surface 4.1 to the length of the front surface 4.2 may be approximately four to one. In other possible embodiments, the ratio of the lengths may be higher or possibly lower.

In the vicinity of the vacuum gripper 3 a stop 5 is provided, against which the blanks 2 are in contact with their upper edge. At the same time, an additional stop 6 is provided on the bottom which is connected with a pressure measurement sensor 7. The stops 5 and 6 are oriented so that the blanks 2 are inclined slightly in the direction of transport. Because the stops 5 and 6 are mounted on one side, the blanks 2 can easily be extracted laterally.

A retaining device is also provided at a certain distance from the vacuum gripper 3. This retaining device is realized in the form of a clamping device 8 which grips the blanks 2 on the side so that they can be clamped in it. In this manner, the pressure exerted by the transported blanks 2 on the stops 5 and 6 can be reduced to almost zero, or whatever level is required or desired. For assistance, the extraction section 9 and the magazine section 10 of the device 1 are also structurally separate from each other and are oriented at an angle to each other.

The function of the magazine device according to the present application is described below:

By means of the pressure sensor 7, which can also be located on the upper stop 5 and which can be realized in the form of known pressure sensors, the contact pressure exerted by the blanks in contact with it can be measured. This contact pressure drops as soon as a blank 2 is extracted by the vacuum gripper 3 and increases as soon as the blanks are moved in the direction of the vacuum gripper 3 by the transport device 4.

The speed of the conveyor device 4 can be made a direct function of the extraction speed (blanks per hour) of the vacuum gripper 3 and controlled accordingly or set by the use of the signal from the pressure sensor 7. This method essentially ensures or promotes on one hand that there will be a sufficient number of blanks 2 in contact with the stops 5 and 6 and essentially guarantees or promotes a reliable pick-up by the vacuum gripper 3 and on the other hand essentially ensures or promotes that the contact pressure is never so high that an extraction of the next blank 2 is no longer possible.

As a result of the use of the clamping device 8, it is essentially guaranteed or promoted that the magazine capacity in the vicinity of the magazine section 10 can be increased practically at will up to the load limit of the transport device 4. As a result of the increasing number of blanks 2 pressing against the stops, the contact pressure on the stops 5 and 6 would be significantly increased, at least temporarily. This undesirable increase in the contact pressure is prevented, restricted, or minimized by the clamping device 8. If the measured contact pressure increases, for example, beyond a specified level that essentially guarantees or promotes a secure and reliable extraction, the clamping device 8 is activated and clamps down on the blanks in between and thus separates them from the stops. At the same time and in accordance with one possible embodiment, the conveyor chain 4 is deactivated in this area. The remaining blanks 2 which are between the clamping device 8 and the stops 5 and 6 then press with their own weight and thrust against the stops 5 and 6, so that the contact pressure decreases and a secure and reliable extraction is once again possible. As soon as the pressure has decreased below an additional specified value, the clamping device 8 is deactivated and the conveyor chain 4 is reactivated in this area, so that additional blanks 2 can be advanced into the extraction section 9 of the magazine device until the pressure once again exceeds the first level.

In this manner, on one hand it is essentially ensured or promoted that a sufficient number of blanks 2 is available for extraction and on the other hand, as described, the contract pressure never or substantially never reaches critical levels.

In another configuration, instead of the clamping device 8, friction elements can also be used which do not completely grasp the blanks 2, but generate an elevated friction component, so that its influence on the contact pressure is reduced and a continuous pressure control becomes possible.

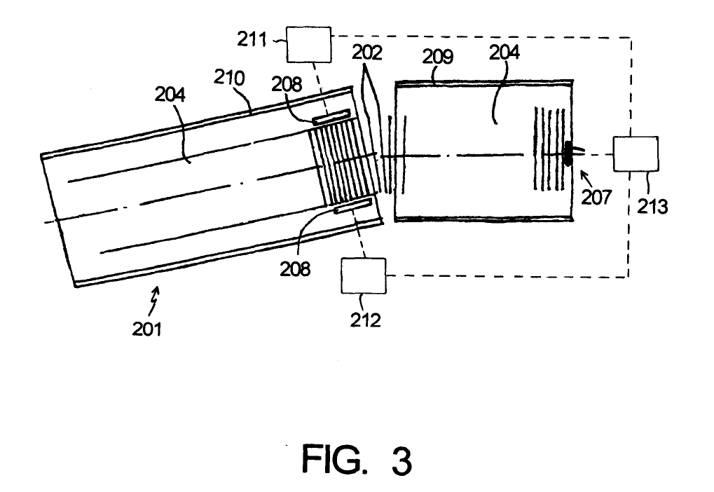

FIG. 3 shows at least one other possible embodiment of a magazine device 201. In this device, flat elements 202 are moved on a conveyor 204 from a magazine or supply section 210 to an extraction section 209. In this embodiment, friction elements 208 are movable elements which can be individually controlled to produce a range of friction force on the flat elements 202. To further explain, the friction elements 208 can be moved in a gripping motion toward the flat elements 202 until a desired level of engagement is achieved. For example, the friction elements 208 could be moved toward the flat elements 202 a distance sufficient to produce a relatively strong friction force sufficient to virtually stop the movement of the flat elements 202, similarly to the manner in which the gripper 8 operates as described above. On the other hand, the friction elements 208 could be moved toward the flat elements 202 a smaller distance sufficient to produce a relatively small friction force sufficient to inhibit or slow the movement of the flat elements 202. The amount of friction force or level of engagement could be determined based on the data measured by the pressure sensor 207. For example, if the pressure sensor 207 detects a contact pressure that is very high or near an undesirable level, the friction elements 208 could be moved to strongly engage the flat elements 202 to strongly inhibit or essentially prevent movement of the flat elements 202 to produce a sudden and substantial decrease in the contact pressure back to a desired or acceptable level. On the other hand, if the contact pressure is elevated but not near an undesirable level, the friction elements 208 could be moved to moderately engage the flat elements 202 to inhibit movement of the flat elements 202 to produce a decrease in the contact pressure. In another example, friction elements 208 could be moved back and forth continuously or substantially continuously in order to maintain the contact pressure at approximately a desired level during the operation of the machine. To further explain, if the pressure sensor 207 measures or detects a slight increase in the contact pressure, the friction elements 208 could correspondingly slightly engage the flat elements 202 in order to inhibit their movement and decrease the contact pressure. If the contact pressure continues to increase, the friction elements 208 could be moved further to engage the flat elements 202 in a stronger manner and with a greater friction force in order to decrease the contact pressure. In this manner, the friction elements 208 could be constantly or substantially constantly adjusted with respect to their level of engagement with the flat elements 202 in order to produce varying levels of friction force in response to increases and decreases in the contact pressure. In this manner a substantially constant contact pressure could be maintained or promoted while substantial increases or decreases in the contact pressure could be minimized or essentially avoided. In addition, in at least one possible embodiment, the conveyor 204 would not be slowed or stopped at any time during operation of the machine to adjust the contact pressure as the action of the friction elements 208 on the flat elements 202 would be sufficient to control the contact pressure. In the embodiment shown in FIG. 3, step motors or servomotors 212 are utilized to move the friction elements 208, and a control arrangement 213, such as a computer, is utilized to control the back-and-forth movement based on the data received from the pressure sensor 207, although it should be understood that the control and movement of the friction elements 208 could be executed in other ways using different components.

The signals from the pressure sensor 7, as described above, can also be used for the control of the transport speed or for the control of the retaining device and/or for both. The retaining device can also be controlled by means of a timer and/or by means of a counting element as a function of the number of elements extracted and/or the speed of transport. The same is true for the transport speed of the conveyor chain 4 in the vicinity of the magazine section 10 and/or in the vicinity of the extraction section 9. If there is a timer, the retaining device is controlled on the basis of a fixed or variable timing pattern. If the control is in the form of a metering element, the retaining device is controlled as a function of the number of blanks extracted by the extraction device, e.g. the retaining device is activated when every 17th blank is extracted. FIG. 1A shows the control arrangement 213, such as a computer, operatively connected to the different portions of the magazine device 1, such as the vacuum gripper 3, the conveyor chain 4, the pressure measurement sensor 7, and the clamping device 8. The control arrangement 213 is connected to a motor or drive arrangement 214 which is operatively connected to the conveyor chain 4. The control arrangement 213 can control the operation of the drive arrangement 214 to control the movement of the conveyor chain 4. The control arrangement 213 also may be utilized to control the operation of the vacuum gripper 3, the pressure measurement sensor 7, and the clamping device 8. The control arrangement 213 also can comprise the timer and counting element discussed above.

Naturally the present application is not limited to the possible embodiment describe above, but a wide range of modifications and variations can be made to it without thereby going beyond the teaching of the present application. Both the construction of the individual machine parts, their number and configuration, can be varied and modified in many different ways.

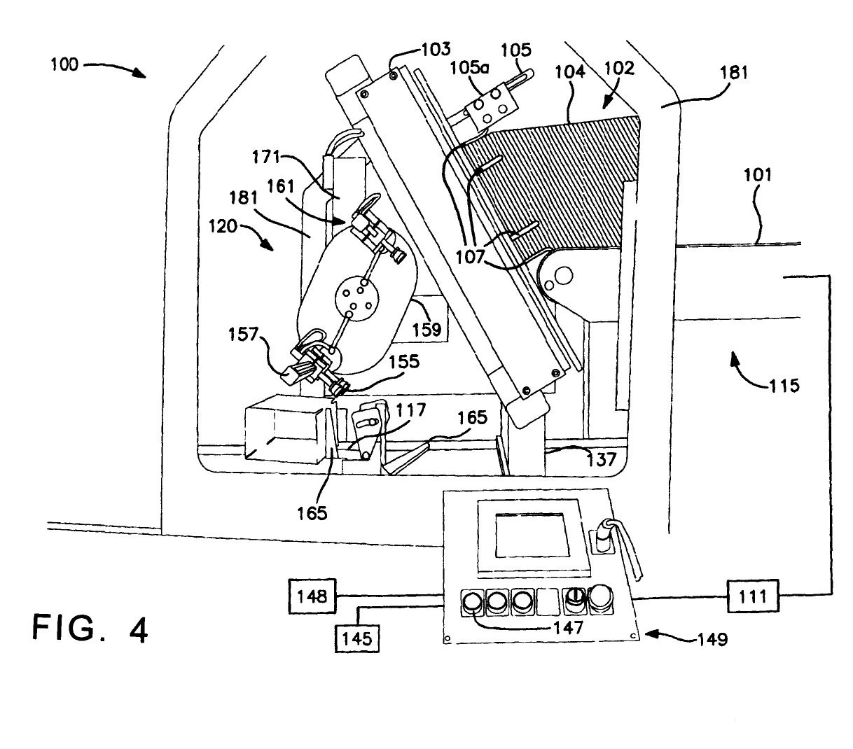

FIG. 4 shows a cartoner assembly 100 for receiving a supply of flat, folded cartons 104 and then opening the folded cartons 104 to form open cartons or boxes for insertion of a product therein. In at least one possible embodiment, the cartoner assembly 100 can be an intermittent cartoner. In another possible embodiment, the cartoner assembly 100 can be a continuous motion cartoner. The folded cartons 104 are fed from a carton magazine or carton supply 102. A portion of the folded cartons 104 are supported on a motorized belt 101 of a guide conveyor 115, which is driven by a belt drive motor 111. The guide conveyor 115 is operatively connected to the cartoner frame 181. The motorized belt 101 moves the folded cartons 104 forward to an adjustable face plate or adjustable carton guide 103.

While the adjustable face plate 103 holds and guides a portion of the folded cartons 104 that have been moved forward on the motorized belt 101, the carton supply 102 continues to feed folded cartons 104 on the motorized belt 101 toward the face plate 103. In at least one possible embodiment, the folded cartons 104 are moved forward intermittently as the supply fed to the face plate 103 is depleted. To control the intermittent operation of the belt drive motor 111 and the motorized belt 101, a sensor 105a is mounted on the face plate 103 via a sensor mount 105. In at least one possible embodiment, the sensor 105a can be a photoelectric sensor. The sensor 105a is positioned and designed to sense and monitor the supply of folded cartons 104 on the guide conveyor 115. During operation of the cartoner assembly 100, the folded cartons 104 are removed from the face plate 103, thereby depleting the number of folded cartons 104 in the carton supply 102. When the sensor 105a senses that there is a shortage of cartons or a low carton supply in the carton supply 102 on the motorized belt 101, the sensor 105a sends a signal to the belt drive motor 111 to actuate the belt drive motor 111, and thus feed more folded cartons 104 into the face plate 103. Once a desired or appropriate supply or number of folded cartons 104 is reestablished, the sensor 105a sends a signal to the belt drive motor 111 to stop the belt drive motor 111 and terminate the forward movement of the motorized belt 101.

As shown in FIG. 4, the motorized belt 101 transports the folded cartons 104 in a manner substantially parallel to the ground toward the face plate 103. As the folded cartons 104 approach the face plate 103, the folded cartons 104 begin a substantially downward descent as they travel off of the motorized belt 101 and onto guide rods 107 of the face plate 103. The folded cartons 104 are then moved forward toward the face plate 103 by means of force generated by the motorized belt 101, as well as pressure from the weight of the folded cartons 104 in the carton supply 102. As the folded cartons 104 move in a substantially downward direction, guide rods 107 on the face plate 103 assist in the positioning of the folded cartons 104 as they enter the face plate 103. Once the folded cartons 104 are within the face plate 103, stop tabs 133 located at the ends 108 of the guide rods 107 prevent the folded cartons 104 from moving any further forward.

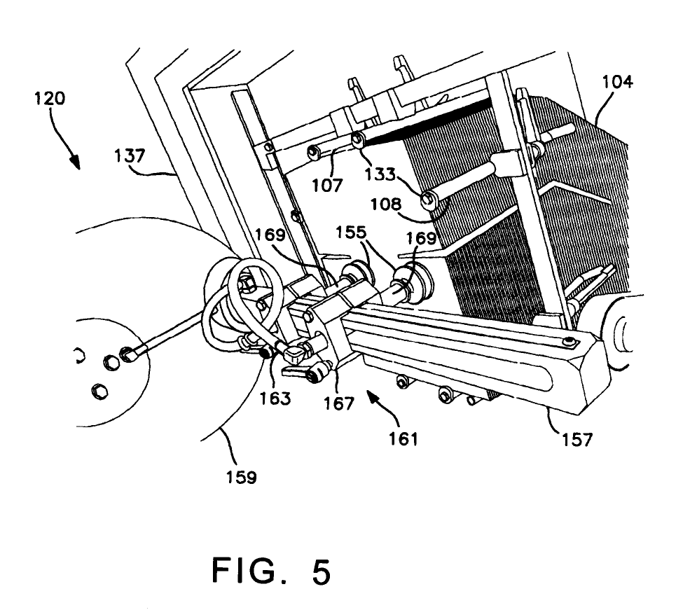

Referring to FIG. 5, the folded cartons 104 are transported out of the adjustable magazine face plate 103 by means of a rotary feeder apparatus 120. The rotary feeder apparatus 120 is attached to the cartoner frame 181 by a support structure 171, as seen in FIG. 4, and includes an oval-shaped rotary plate 159 that is rotated about a center axis by a drive mechanism (not shown). Two arms or projecting bars 157 are mounted on opposite ends of the rotary plate 159 and project out substantially perpendicularly from the face of the rotary plate 159. It should be noted that in at least one possible embodiment, three or four arms or projecting bars 157 could be mounted on the rotary plate 159, which plate 159 could also be circular or elliptical in shape. Each of the arms or bars 157 is individually rotated about a center axis in a direction opposite the direction of rotation of the rotary plate 159 by a drive mechanism (not shown). For example, if the rotary plate 159 is rotating about its axis in a clockwise direction, the arms 157 individually rotate simultaneously about their axes in a counterclockwise direction.

On each of the arms 157 is mounted a carton retrieval arrangement 161 that grabs the folded cartons 104 and places the folded cartons 104 on the lower conveyor belt 117 (as seen in FIG. 4). The projecting bar 157 penetrates or passes through a holding structure 167 of the carton retrieval arrangement 161. A pair of shafts 169 pass through and project outwardly from the holding structure 167. On the ends of the shafts 169, there are vacuum suction cups 155 that are used to contact and remove the folded cartons 104 from the face plate 103. The vacuum cups 155 are connected to a vacuum source (not shown) by the shafts 169 and a hose arrangement 163. The vacuum source creates sufficient suction inside the hose arrangement 163 and shafts 169 to permit the vacuum cups 155 to overcome the retaining force of the stop tabs 133 and remove the folded cartons 104 from the face plate 103. The vacuum cups 155, which are rotating as part of the carton retrieval arrangement 161, release and place the folded cartons 104 on the lower conveyor belt 117 (as seen in FIG. 4) for further transportation.

Referring to FIG. 4, the rotary feeder apparatus 120 transports the folded cartons 104 out of the face plate 103 via vacuum cups 155. When the folded cartons 104 approach the lower conveyor belt 117, the folded cartons 104 are opened up between a pair of set up cams or projecting panels or frames 165 that are attached to or move with the lower conveyor belt 117. The set up cams 165 are a series of projecting members on or adjacent the lower conveyor belt 117 that are spaced apart to receive and hold an opened carton there between. As the rotary feeder apparatus 120 brings the folded cartons 104 downwards from the face plate 103 in a swinging motion, the force generated by the rotating arm 157 moving forward in a substantially downward direction and the impact of the folded carton 104 with the set up cams 165, continuously moving forward on the lower conveyor belt 117, forces the folded cartons 104 to open. In addition, the same force that causes the folded cartons 104 to open also overcomes the suction of the vacuum cups 155 on the rotary feeder apparatus 120 and the open carton is released from the vacuum cups 155 between the set up cams 165. The open cartons located between the set up cams 165 are then transported forward on the lower conveyor belt 117 for future packing.

In operation, the cartoner assembly 100 receives a supply of folded cartons 104 in the carton supply 102 on the guide conveyor 115. The motorized belt 101 of the guide conveyor 115 transports the folded cartons 104 forward into the face plate 103. While the face plate 103 holds a portion of the folded cartons 104, the remainder of the folded cartons 104 are located on the guide conveyor 115. The force generated by the motorized belt 101, as well as pressure from the weight of the folded cartons 104 in the carton supply 102 pushes the folded cartons 104 into the guide rods 107a-d on the face plate 103.

In one embodiment, the folded cartons 104 on the guide conveyor 115 are intermittently moved forward by the motorized belt 101. In this embodiment, the sensor 105a on the face plate 103 will sense a shortage of folded cartons 104 on the guide conveyor 115. When the sensor 105a detects a shortage of folded cartons 104 on the guide conveyor 115, the sensor 105a will signal the belt drive motor 111 to actuate the belt drive motor 111, and thus feed more folded cartons 104 via the motorized belt 101 into the face plate 103. When the folded cartons 104 slide into the guide rods 107a-d on the face plate 103, the folded cartons are held in place by the stop tabs 133 to be transported out of the face plate 103.

The rotary feeder apparatus 120 with vacuum cups 155 then grabs an individual folded carton 104 out of the stop tabs 133 of the face plate 103. To further explain, the rotary plate 159 rotates in a clockwise direction and the carton retrieval arrangements 161, located on the rotary plate 159, individually rotate simultaneously about their axes in a counterclockwise direction. When one of the carton retrieval arrangements 161 reach the folded cartons 104 in the stop tabs 133, the vacuum cups 155 grab the folded carton 104 and rotate the folded carton counterclockwise with the arm 157. When the carton retrieval arrangement 161 swings the folded carton 104 in a substantially downward direction during this counterclockwise rotation, the folded carton 104 comes in direct contact with the set up cam 165 on the moving lower conveyor belt 117. The force generated by the swinging motion of the rotary feeder apparatus 120, in addition to the connection of the folded carton 104 with the set up cam 165, forces the folded carton 104 to open and the vacuum cups 155 to release the now open carton. The now open carton is positioned between a pair of set up cams 165 on the lower conveyor belt 117 and is transported forward on the lower conveyor belt 117 for future packing.

FIGS. 4 and 5 and the corresponding description thereof may be found in U.S. patent application Ser. No. 11/936,845, filed Nov. 8, 2007, and having inventor Scott Veix, which application is incorporated by reference herein.

A magazine device for flat elements in contact with one another with at least one transport device and at least one extraction device, wherein a retaining device is provided in the direction of transport upstream of the extraction device is improved so that the maximum capacity is increased, the ease of operation is improved and the susceptibility to malfunctions is reduced.

The present application teaches that a retaining device is provided upstream of the extraction device in the direction of transport.

One feature or aspect of an embodiment is believed at the time of the filing of this patent application to possibly reside broadly in a magazine device for flat elements in contact with one another with at least one transport device and at least one extraction device, wherein a retaining device is provided in the direction of transport upstream of the extraction device.

Another feature or aspect of an embodiment is believed at the time of the filing of this patent application to possibly reside broadly in a magazine device for flat elements in contact with one another with at least one transport device and at least one extraction device, whereby a retaining device is provided in the direction of transport upstream of the extraction device, wherein a sensor 7 is provided for the measurement of the contact pressure of the flat elements in the vicinity of the extraction device and the retaining device is realized so that it can be controlled as a function of the measured contact pressure.

Yet another feature or aspect of an embodiment is believed at the time of the filing of this patent application to possibly reside broadly in the magazine device, wherein the transport device is realized in the form of a conveyor chain 4 with chain links that have an ascending ramp shape in the direction of transport.

Still another feature or aspect of an embodiment is believed at the time of the filing of this patent application to possibly reside broadly in the magazine device, wherein the flat elements on the transport device are transported essentially vertically and/or inclined in the direction of transport.

A further feature or aspect of an embodiment is believed at the time of the filing of this patent application to possibly reside broadly in the magazine device, wherein the advance speed of the transport device is realized so that it can be controlled as a function of the extraction speed, the extraction device and/or the measured contact pressure.

Another feature or aspect of an embodiment is believed at the time of the filing of this patent application to possibly reside broadly in the magazine device, wherein the retaining device is realized in the form of a clamping device 8 which acts laterally on the flat elements and/or in the form of an adjustable friction element.

Yet another feature or aspect of an embodiment is believed at the time of the filing of this patent application to possibly reside broadly in magazine device for flat elements in contact with one another with at least one transport device and at least one extraction device, whereby a retaining device is provided in the direction of transport upstream of the extraction device, wherein the transport device is realized in the form of a conveyor chain 4 with chain links that have an ascending ramp shape in the direction of transport.

Still another feature or aspect of an embodiment is believed at the time of the filing of this patent application to possibly reside broadly in the magazine device, wherein the flat elements on the transport device are transported essentially vertically and/or inclined in the direction of transport.

A further feature or aspect of an embodiment is believed at the time of the filing of this patent application to possibly reside broadly in the magazine device, wherein a sensor 7 is provided for the measurement of the contact pressure of the flat elements in the vicinity of the extraction device.

One feature or aspect of an embodiment is believed at the time of the filing of this patent application to possibly reside broadly in the magazine device, wherein the retaining device is realized so that it can be controlled as a function of the measured contact pressure.

Another feature or aspect of an embodiment is believed at the time of the filing of this patent application to possibly reside broadly in the magazine device, wherein the advance speed of the transport device is realized so that it can be controlled as a function of the extraction speed of the extraction device and/or of the measured contact pressure.

Yet another feature or aspect of an embodiment is believed at the time of the filing of this patent application to possibly reside broadly in the magazine device, wherein the retaining device is realized in the form of a clamping device 8 which acts laterally on the flat elements and/or in the form of an adjustable friction element.

Still another feature or aspect of an embodiment is believed at the time of the filing of this patent application to possibly reside broadly in a method for the control of a magazine device according to the present application, wherein the contact pressure of the flat elements in the vicinity of the extraction device is measured by means of a sensor 7 and the retaining device is controlled as a function of the contact pressure measured.

A further feature or aspect of an embodiment is believed at the time of the filing of this patent application to possibly reside broadly in the method, wherein the retaining device is activated when a specified measured contact pressure is exceeded and/or as a function of a timer.

Yet another feature or aspect of an embodiment is believed at the time of the filing of this patent application to possibly reside broadly in the method, wherein the advance speed of the transport device is reduced when a specified measured contact pressure is exceeded.

Another feature or aspect of an embodiment is believed at the time of the filing of this patent application to possibly reside broadly in a method of feeding flattened cardboard cartons in a carton opening machine for use in a bottle or container packaging arrangement, said method comprising the steps of: placing a plurality of flattened cardboard cartons on edge and stacked face to face in a carton supply magazine, wherein a first carton of said plurality of cartons is disposed nearest an exit end of said carton supply magazine and is pressed up against at least one stop element at said exit end of said carton supply magazine; removing said first carton from said carton supply magazine and substantially simultaneously advancing said plurality of cartons forward toward said exit end of said carton supply magazine until a second carton subsequent to said first carton is pressed up against said at least one stop element; repeating said steps of removing cartons and advancing cartons for subsequent cartons; continuously monitoring and measuring an amount of pressing force exerted on said at least one stop element by said plurality of cartons during advancement and removal of cartons; activating, upon detecting a pressing force higher than or approximately the same as a maximum predetermined pressing force, a pair of carton retaining devices disposed upstream and a distance from said exit end of said carton supply magazine, wherein one retaining device is disposed on each side of said plurality of cartons; physically engaging opposing side edges of a group of said plurality of cartons with said pair of retaining devices to decrease advancement of the engaged group of cartons and any subsequent cartons disposed upstream thereof to reduce the number of cartons pressing on said at least one stop and thus reduce the pressing force on said at least one stop produced by the advancing cartons; and sufficiently reducing the pressing force on said at least one stop produced by the advancing cartons and reducing said engagement by said retaining devices.

Still another feature or aspect of an embodiment is believed at the time of the filing of this patent application to possibly reside broadly in the method, wherein: said step of physically engaging a group of said plurality of cartons with said retaining devices comprises clamping the engaged group of cartons with said retaining devices and completely stopping the advancement of the engaged group of cartons and any subsequent cartons disposed upstream thereof; and said step of reducing said engagement of said retaining devices comprises disengaging said retaining devices from the engaged group of cartons.

Yet another feature or aspect of an embodiment is believed at the time of the filing of this patent application to possibly reside broadly in the method, wherein: said step of physically engaging a group of said plurality of cartons with said retaining devices comprises continuously adjusting the amount of engagement of said retaining devices with the engaged group of cartons by increasing and decreasing the amount of engagement of the engaged group of cartons in proportion to the measured amount of the pressing force on said at least one stop produced by the advancing cartons in order to maintain the amount of the pressing force on said at least one stop at approximately a predetermined level.

A further feature or aspect of an embodiment is believed at the time of the filing of this patent application to possibly reside broadly in a means for performing the method, comprising: means for placing a plurality of flattened cardboard cartons on edge and stacked face to face in a carton supply magazine, wherein a first carton of said plurality of cartons is disposed nearest an exit end of said carton supply magazine and is pressed up against at least one stop element at said exit end of said carton supply magazine; means for removing said first carton from said carton supply magazine and means for substantially simultaneously advancing said plurality of cartons forward toward said exit end of said carton supply magazine until a second carton subsequent to said first carton is pressed up against said at least one stop element; means for continuously monitoring and measuring an amount of pressing force exerted on said at least one stop element by said plurality of cartons during advancement and removal of cartons; means for activating, upon detecting a pressing force higher than or approximately the same as a maximum predetermined pressing force, a pair of carton retaining devices disposed upstream and a distance from said exit end of said carton supply magazine, wherein one retaining device is disposed on each side of said plurality of cartons; said retaining devices comprising means for physically engaging opposing side edges of a group of said plurality of cartons with to decrease advancement of the engaged group of cartons and any subsequent cartons disposed upstream thereof to reduce the number of cartons pressing on said at least one stop and thus reduce the pressing force on said at least one stop produced by the advancing cartons; and said retaining devices comprising means for sufficiently reducing the pressing force on said at least one stop produced by the advancing cartons and reducing said engagement by said retaining devices.

Another feature or aspect of an embodiment is believed at the time of the filing of this patent application to possibly reside broadly in an arrangement for performing the method, said arrangement comprising: a placing arrangement being configured to place a plurality of flattened cardboard cartons on edge and stacked face to face in a carton supply magazine, wherein a first carton of said plurality of cartons is disposed nearest an exit end of said carton supply magazine and is pressed up against at least one stop element at said exit end of said carton supply magazine; a removing arrangement being configured to remove said first carton from said carton supply magazine and a conveying arrangement being configured to substantially simultaneously advance said plurality of cartons forward toward said exit end of said carton supply magazine until a second carton subsequent to said first carton is pressed up against said at least one stop element; a monitoring and measuring arrangement being configured to continuously monitor and measure an amount of pressing force exerted on said at least one stop element by said plurality of cartons during advancement and removal of cartons; an activating arrangement being configured to activate, upon detecting a pressing force higher than or approximately the same as a maximum predetermined pressing force, a pair of carton retaining devices disposed upstream and a distance from said exit end of said carton supply magazine, wherein one retaining device is disposed on each side of said plurality of cartons; said pair of carton retaining devices being configured to physically engage opposing side edges of a group of said plurality of cartons with said pair of retaining devices to decrease advancement of the engaged group of cartons and any subsequent cartons disposed upstream thereof to reduce the number of cartons pressing on said at least one stop and thus reduce the pressing force on said at least one stop produced by the advancing cartons; and said pair of carton retaining devices being configured to sufficiently reduce the pressing force on said at least one stop produced by the advancing cartons and said activating arrangement being configured to reduce said engagement by said retaining devices.

Yet another feature or aspect of an embodiment is believed at the time of the filing of this patent application to possibly reside broadly in a method of feeding flattened containers in a container opening machine for use in a packaging arrangement, said method comprising the steps of: placing a plurality of flattened containers on edge and stacked face to face in a container supply magazine, wherein a first container of said plurality of containers is disposed nearest an exit end of said container supply magazine and is pressed up against at least one stop element at said exit end of said container supply magazine; removing said first container from said container supply magazine and substantially simultaneously advancing said plurality of containers forward toward said exit end of said container supply magazine until a second container subsequent to said first container is pressed up against said at least one stop element; repeating said steps of removing containers and advancing containers for subsequent containers; continuously monitoring and measuring an amount of pressing force exerted on said at least one stop element by said plurality of containers during advancement and removal of containers; engaging and retaining a group of said plurality of containers upstream and a distance from said exit end of said container supply magazine, upon detecting a pressing force higher than or approximately the same as a maximum predetermined pressing force, to decrease advancement of the engaged group of containers and any subsequent containers disposed upstream thereof to reduce the number of containers pressing on said at least one stop and thus reduce the pressing force on said at least one stop produced by the advancing containers; and sufficiently reducing the pressing force on said at least one stop produced by the advancing containers and reducing said engagement of the engaged group of containers.

Still another feature or aspect of an embodiment is believed at the time of the filing of this patent application to possibly reside broadly in the method, wherein: said step of engaging and retaining a group of said plurality of containers comprises clamping the engaged group of containers with a pair of retaining devices and completely stopping the advancement of the engaged group of containers and any subsequent containers disposed upstream thereof; and said step of reducing said engagement of the engaged group of containers comprises disengaging said retaining devices from the engaged group of containers.

A further feature or aspect of an embodiment is believed at the time of the filing of this patent application to possibly reside broadly in the method, wherein: said step of engaging and retaining a group of said plurality of containers comprises physically engaging and retaining the group of said plurality of containers with at least one retaining device and continuously adjusting the amount of engagement of said at least one retaining device with the engaged group of containers by increasing and decreasing the amount of engagement of the engaged group of containers in proportion to the measured amount of the pressing force on said at least one stop produced by the advancing containers in order to maintain the amount of the pressing force on said at least one stop at approximately a predetermined level.

Another feature or aspect of an embodiment is believed at the time of the filing of this patent application to possibly reside broadly in a means for performing the method comprising: means for placing a plurality of flattened containers on edge and stacked face to face in a container supply magazine, wherein a first container of said plurality of containers is disposed nearest an exit end of said container supply magazine and is pressed up against at least one stop element at said exit end of said container supply magazine; means for removing said first container from said container supply magazine and means for substantially simultaneously advancing said plurality of containers forward toward said exit end of said container supply magazine until a second container subsequent to said first container is pressed up against said at least one stop element; means for continuously monitoring and measuring an amount of pressing force exerted on said at least one stop element by said plurality of containers during advancement and removal of containers; means for engaging and retaining a group of said plurality of containers upstream and a distance from said exit end of said container supply magazine, upon detecting a pressing force higher than or approximately the same as a maximum predetermined pressing force, to decrease advancement of the engaged group of containers and any subsequent containers disposed upstream thereof to reduce the number of containers pressing on said at least one stop and thus reduce the pressing force on said at least one stop produced by the advancing containers; and means for engaging and retaining comprising means for sufficiently reducing the pressing force on said at least one stop produced by the advancing containers and means for reducing said engagement of the engaged group of containers.

Still another feature or aspect of an embodiment is believed at the time of the filing of this patent application to possibly reside broadly in an arrangement for performing the method, said arrangement comprising: a placing arrangement being configured to place a plurality of flattened containers on edge and stacked face to face in a container supply magazine, wherein a first container of said plurality of containers is disposed nearest an exit end of said container supply magazine and is pressed up against at least one stop element at said exit end of said container supply magazine; a removing arrangement being configured to remove said first container from said container supply magazine and an advancing arrangement being configured to substantially simultaneously advance said plurality of containers forward toward said exit end of said container supply magazine until a second container subsequent to said first container is pressed up against said at least one stop element; a monitoring and measuring arrangement being configured to continuously monitor and measure an amount of pressing force exerted on said at least one stop element by said plurality of containers during advancement and removal of containers; an engaging and retaining arrangement being configured to engage and retain a group of said plurality of containers upstream and a distance from said exit end of said container supply magazine, upon detecting a pressing force higher than or approximately the same as a maximum predetermined pressing force, to decrease advancement of the engaged group of containers and any subsequent containers disposed upstream thereof to reduce the number of containers pressing on said at least one stop and thus reduce the pressing force on said at least one stop produced by the advancing containers; and said engaging and retaining arrangement being configured to sufficiently reduce the pressing force on said at least one stop produced by the advancing containers and being configured to reduce said engagement with the engaged group of containers.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

The following patents, patent applications or patent publications, are hereby incorporated by reference as if set forth in their entirety herein: DE 26 25 237 A1, having the following English translation of the German title “FEED DEVICE FOR PRINTED SHEETS,” published on Feb. 3, 1977; DD 285324, having the following German title “VORRICHTUNG ZUM STEUERN VON FÜRDERELEMENTEN FÜR AUS FLACHEN GEGENSTÄNDEN, INSBESONDERE DRUCKBOGEN, BESTEHENDE STAPEL,” published on Dec. 12, 1990; and DE 42 00 186 C1, having the following English translation of the German title “SHEET EXTRACTING DEVICE WITH A CASSETTE FOR RECEIVING A STACK OF SHEETS,” published on Jul. 15, 1993.

All of the patents, patent applications or patent publications, which were cited in the International Search Report dated Dec. 20, 2007, and/or cited elsewhere are hereby incorporated by reference as if set forth in their entirety herein as follows: U.S. Pat. No. 4,518,301, having the title “ORBITAL FEEDER,” published on May 21, 1985; EP 1,266,833, having the title “DEVICE FOR INDIVIDUALLY TRANSFERRING CARDBOARD BLANKS TO A COLLECTION AREA,” published on Dec. 18, 2002; DE 200 00 931, having the following German title “MAGAZIN MIT ENTNAHMEBEREICH,” published on Jul. 13, 2000; and EP 0,972,708, having the title “DEVICE FOR FEEDING BLANKS ON A PACKING MACHINE,” published on Jul. 7, 2004.

The patents, patent applications, and patent publication listed above in the preceding two paragraphs are incorporated by reference as if set forth in their entirety herein. The purpose of incorporating U.S. patents, Foreign patents, publications, etc. is solely to provide additional information relating to technical features of one or more embodiments, which information may not be completely disclosed in the wording in the pages of this application. Words relating to the opinions and judgments of the author and not directly relating to the technical details of the description of the embodiments therein are not incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not considered to be incorporated by reference herein.

The corresponding foreign and international patent publication applications, namely, Federal Republic of Germany Patent Application No. 10 2006 038 656.6, filed on Aug. 18, 2006, having inventors Helmut VAN HEEK, Thomas LELIE, Dirk HOLTMANN, Michael JOERISSEN, and Josef DÜPPER, and 10 2006 038 656.6 and DE-PS 10 2006 038 656.6, and International Application No. PCT/EP2007/007227, filed on Aug. 16, 2007, having WIPO Publication No. WO 2008/019845 and inventors Helmut VAN HEEK, Thomas LELIE, Dirk HOLTMANN, Michael JOERISSEN, and Josef DÜPPER, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

The purpose of incorporating the Foreign equivalent patent application PCT/EP2007/007227 and German Patent Application 10 2006 038 656.6 is solely for the purpose of providing a basis of correction of any wording in the pages of the present application, which may have been mistranslated or misinterpreted by the translator. Words relating to opinions and judgments of the author and not directly relating to the technical details of the description of the embodiments therein are not to be incorporated by reference. The words all, always, absolutely, consistently, preferably, guarantee, particularly, constantly, ensure, necessarily, immediately, endlessly, avoid, exactly, continually, expediently, need, must, only, perpetual, precise, perfect, require, requisite, simultaneous, total, unavoidable, and unnecessary, or words substantially equivalent to the above-mentioned word in this sentence, when not used to describe technical features of one or more embodiments, are not generally considered to be incorporated by reference herein.

Statements made in the original foreign patent applications PCT/EP2007/007227 and DE 10 2006 038 656.6 from which this patent application claims priority which do not have to do with the correction of the translation in this patent application are not to be included in this patent application in the incorporation by reference.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

1 Magazine device
2 Blanks
3 Vacuum gripper
4 Conveyor chain
5 Stop
6 Stop
7 Pressure measurement sensor
8 Clamping device
9 Extraction section
10 Magazine section

What is claimed is:

1. A method of feeding flattened cardboard cartons in a carton opening machine for use in a bottle or container packaging arrangement, said method comprising the steps of:
placing a plurality of flattened cardboard cartons on edge and stacked face to face in a carton supply magazine, wherein a first carton of said plurality of cartons is disposed nearest an exit end of said carton supply magazine and is pressed up against at least one stop element at said exit end of said carton supply magazine;
removing said first carton from said carton supply magazine and substantially simultaneously advancing said plurality of cartons forward toward said exit end of said carton supply magazine until a second carton subsequent to said first carton is pressed up against said at least one stop element;
repeating said steps of removing cartons and advancing cartons for subsequent cartons;
continuously monitoring and measuring an amount of pressing force exerted on said at least one stop element by said plurality of cartons during advancement and removal of cartons;
activating, upon detecting a pressing force higher than or approximately the same as a maximum predetermined pressing force, a pair of carton retaining devices disposed upstream and a distance from said exit end of said carton supply magazine, wherein one retaining device is disposed on each side of said plurality of cartons;
physically engaging opposing side edges of a group of said plurality of cartons with said pair of retaining devices to decrease advancement of the engaged group of cartons and any subsequent cartons disposed upstream thereof to reduce the number of cartons pressing on said at least one stop and thus reduce the pressing force on said at least one stop produced by the advancing cartons; and
sufficiently reducing the pressing force on said at least one stop produced by the advancing cartons and reducing said engagement by said retaining devices.

2. The method according to claim 1, wherein:
said step of physically engaging a group of said plurality of cartons with said retaining devices comprises clamping the engaged group of cartons with said retaining devices and completely stopping the advancement of the engaged group of cartons and any subsequent cartons disposed upstream thereof; and
said step of reducing said engagement of said retaining devices comprises disengaging said retaining devices from the engaged group of cartons.

3. The method according to claim 2, wherein:
the transport device is realized in the form of a conveyor chain with chain links that have an ascending ramp shape in the direction of transport;
the flat elements on the transport device are transported essentially vertically and/or inclined in the direction of transport;
the advance speed of the transport device is realized so that it can be controlled as a function of the extraction speed, the extraction device and/or the measured contact pressure;
the retaining device is activated when a specified measured contact pressure is exceeded and/or as a function of a timer; and
the advance speed of the transport device is reduced when a specified measured contact pressure is exceeded.

4. The method according to claim 1, wherein:
said step of physically engaging a group of said plurality of cartons with said retaining devices comprises continuously adjusting the amount of engagement of said retaining devices with the engaged group of cartons by increasing and decreasing the amount of engagement of the engaged group of cartons in proportion to the measured amount of the pressing force on said at least one stop produced by the advancing cartons in order to maintain the amount of the pressing force on said at least one stop at approximately a predetermined level.

5. The method according to claim 4, wherein:
the transport device is realized in the form of a conveyor chain with chain links that have an ascending ramp shape in the direction of transport;
the flat elements on the transport device are transported essentially vertically and/or inclined in the direction of transport;
the advance speed of the transport device is realized so that it can be controlled as a function of the extraction speed, the extraction device and/or the measured contact pressure;
the retaining device is activated when a specified measured contact pressure is exceeded and/or as a function of a timer; and
the advance speed of the transport device is reduced when a specified measured contact pressure is exceeded.

6. A means for performing the method of claim 1, comprising:
means for placing a plurality of flattened cardboard cartons on edge and stacked face to face in a carton supply magazine, wherein a first carton of said plurality of cartons is disposed nearest an exit end of said carton supply magazine and is pressed up against at least one stop element at said exit end of said carton supply magazine;
means for removing said first carton from said carton supply magazine and means for substantially simultaneously advancing said plurality of cartons forward toward said exit end of said carton supply magazine until a second carton subsequent to said first carton is pressed up against said at least one stop element;
means for continuously monitoring and measuring an amount of pressing force exerted on said at least one stop element by said plurality of cartons during advancement and removal of cartons;
means for activating, upon detecting a pressing force higher than or approximately the same as a maximum predetermined pressing force, a pair of carton retaining devices disposed upstream and a distance from said exit end of said carton supply magazine, wherein one retaining device is disposed on each side of said plurality of cartons;
said retaining devices comprising means for physically engaging opposing side edges of a group of said plurality of cartons with to decrease advancement of the engaged group of cartons and any subsequent cartons disposed upstream thereof to reduce the number of cartons pressing on said at least one stop and thus reduce the pressing force on said at least one stop produced by the advancing cartons; and
said retaining devices comprising means for sufficiently reducing the pressing force on said at least one stop produced by the advancing cartons and reducing said engagement by said retaining devices.

7. An arrangement for performing the method according to claim 1, said arrangement comprising:
a placing arrangement being configured to place a plurality of flattened cardboard cartons on edge and stacked face to face in a carton supply magazine, wherein a first carton of said plurality of cartons is disposed nearest an exit end of said carton supply magazine and is pressed up against at least one stop element at said exit end of said carton supply magazine;
a removing arrangement being configured to remove said first carton from said carton supply magazine and a conveying arrangement being configured to substantially simultaneously advance said plurality of cartons forward toward said exit end of said carton supply magazine until a second carton subsequent to said first carton is pressed up against said at least one stop element;
a monitoring and measuring arrangement being configured to continuously monitor and measure an amount of pressing force exerted on said at least one stop element by said plurality of cartons during advancement and removal of cartons;
an activating arrangement being configured to activate, upon detecting a pressing force higher than or approximately the same as a maximum predetermined pressing force, a pair of carton retaining devices disposed upstream and a distance from said exit end of said carton supply magazine, wherein one retaining device is disposed on each side of said plurality of cartons;
said pair of carton retaining devices being configured to physically engage opposing side edges of a group of said plurality of cartons with said pair of retaining devices to decrease advancement of the engaged group of cartons and any subsequent cartons disposed upstream thereof to reduce the number of cartons pressing on said at least one stop and thus reduce the pressing force on said at least one stop produced by the advancing cartons; and
said pair of carton retaining devices being configured to sufficiently reduce the pressing force on said at least one stop produced by the advancing cartons and said activating arrangement being configured to reduce said engagement by said retaining devices.

8. A method of feeding flattened containers in a container opening machine for use in a packaging arrangement, said method comprising the steps of:
placing a plurality of flattened containers on edge and stacked face to face in a container supply magazine, wherein a first container of said plurality of containers is disposed nearest an exit end of said container supply magazine and is pressed up against at least one stop element at said exit end of said container supply magazine;
removing said first container from said container supply magazine and substantially simultaneously advancing said plurality of containers forward toward said exit end of said container supply magazine until a second container subsequent to said first container is pressed up against said at least one stop element;
repeating said steps of removing containers and advancing containers for subsequent containers;
continuously monitoring and measuring an amount of pressing force exerted on said at least one stop element by said plurality of containers during advancement and removal of containers;
engaging and retaining a group of said plurality of containers upstream and a distance from said exit end of said container supply magazine, upon detecting a pressing force higher than or approximately the same as a maximum predetermined pressing force, to decrease advancement of the engaged group of containers and any subsequent containers disposed upstream thereof to reduce the number of containers pressing on said at least one stop and thus reduce the pressing force on said at least one stop produced by the advancing containers; and
sufficiently reducing the pressing force on said at least one stop produced by the advancing containers and reducing said engagement of the engaged group of containers.

9. The method according to claim 8, wherein:
said step of engaging and retaining a group of said plurality of containers comprises clamping the engaged group of containers with a pair of retaining devices and completely stopping the advancement of the engaged group of containers and any subsequent containers disposed upstream thereof; and
said step of reducing said engagement of the engaged group of containers comprises disengaging said retaining devices from the engaged group of containers.

10. The method according to claim 9, wherein:
the transport device is realized in the form of a conveyor chain with chain links that have an ascending ramp shape in the direction of transport;
the flat elements on the transport device are transported essentially vertically and/or inclined in the direction of transport;
the advance speed of the transport device is realized so that it can be controlled as a function of the extraction speed, the extraction device and/or the measured contact pressure;
the retaining device is activated when a specified measured contact pressure is exceeded and/or as a function of a timer; and
the advance speed of the transport device is reduced when a specified measured contact pressure is exceeded.

11. The method according to claim 8, wherein:
said step of engaging and retaining a group of said plurality of containers comprises physically engaging and retaining the group of said plurality of containers with at least one retaining device and continuously adjusting the amount of engagement of said at least one retaining device with the engaged group of containers by increasing and decreasing the amount of engagement of the engaged group of containers in proportion to the measured amount of the pressing force on said at least one stop produced by the advancing containers in order to maintain the amount of the pressing force on said at least one stop at approximately a predetermined level.

12. The method according to claim 11, wherein:
the transport device is realized in the form of a conveyor chain with chain links that have an ascending ramp shape in the direction of transport;
the flat elements on the transport device are transported essentially vertically and/or inclined in the direction of transport;
the advance speed of the transport device is realized so that it can be controlled as a function of the extraction speed, the extraction device and/or the measured contact pressure;
the retaining device is activated when a specified measured contact pressure is exceeded and/or as a function of a timer; and
the advance speed of the transport device is reduced when a specified measured contact pressure is exceeded.

13. A means for performing the method of claim 8 comprising:
means for placing a plurality of flattened containers on edge and stacked face to face in a container supply magazine, wherein a first container of said plurality of containers is disposed nearest an exit end of said container supply magazine and is pressed up against at least one stop element at said exit end of said container supply magazine;
means for removing said first container from said container supply magazine and means for substantially simultaneously advancing said plurality of containers forward toward said exit end of said container supply magazine until a second container subsequent to said first container is pressed up against said at least one stop element;
means for continuously monitoring and measuring an amount of pressing force exerted on said at least one stop element by said plurality of containers during advancement and removal of containers;
means for engaging and retaining a group of said plurality of containers upstream and a distance from said exit end of said container supply magazine, upon detecting a pressing force higher than or approximately the same as a maximum predetermined pressing force, to decrease advancement of the engaged group of containers and any subsequent containers disposed upstream thereof to reduce the number of containers pressing on said at least one stop and thus reduce the pressing force on said at least one stop produced by the advancing containers; and
means for engaging and retaining comprising means for sufficiently reducing the pressing force on said at least one stop produced by the advancing containers and means for reducing said engagement of the engaged group of containers.

14. An arrangement for performing the method of claim 8, said arrangement comprising:
a placing arrangement being configured to place a plurality of flattened containers on edge and stacked face to face in a container supply magazine, wherein a first container of said plurality of containers is disposed nearest an exit end of said container supply magazine and is pressed up against at least one stop element at said exit end of said container supply magazine;
a removing arrangement being configured to remove said first container from said container supply magazine and an advancing arrangement being configured to substantially simultaneously advance said plurality of containers forward toward said exit end of said container supply magazine until a second container subsequent to said first container is pressed up against said at least one stop element;
a monitoring and measuring arrangement being configured to continuously monitor and measure an amount of pressing force exerted on said at least one stop element by said plurality of containers during advancement and removal of containers;
an engaging and retaining arrangement being configured to engage and retain a group of said plurality of containers upstream and a distance from said exit end of said container supply magazine, upon detecting a pressing force higher than or approximately the same as a maximum predetermined pressing force, to decrease advancement of the engaged group of containers and any subsequent containers disposed upstream thereof to reduce the number of containers pressing on said at least one stop and thus reduce the pressing force on said at least one stop produced by the advancing containers; and
said engaging and retaining arrangement being configured to sufficiently reduce the pressing force on said at least one stop produced by the advancing containers and being configured to reduce said engagement with the engaged group of containers.

15. A magazine device for flat elements in contact with one another with at least one transport device and at least one extraction device, whereby a retaining device is provided in the direction of transport upstream of the extraction device, the transport device comprises a conveyor chain with chain links that have an ascending ramp shape in the direction of transport.

16. The magazine device according to claim 15, wherein the flat elements on the transport device are transported essentially vertically and/or inclined in the direction of transport.

17. The magazine device according to claim 16, wherein a sensor is provided for the measurement of the contact pressure of the flat elements in the vicinity of the extraction device.

18. The magazine device according to claim 17, wherein the retaining device is realized so that it can be controlled as a function of the measured contact pressure.

19. The magazine device according to claim 18, wherein the advance speed of the transport device is realized so that it can be controlled as a function of the extraction speed of the extraction device and/or of the measured contact pressure.

20. The magazine device according to claim 19, wherein the retaining device is realized in the form of a clamping device which acts laterally on the flat elements and/or in the form of an adjustable friction element.
